(19) United States
(12) Patent Application Publication
(10) Pub. No.: US 2014/0105588 A1
(43) Pub. Date: Apr. 17, 2014

(54) CAMERA SUPPORT AND FOCUSING AID

(71) Applicant: Darvin Heck, Anderson, CA (US)

(72) Inventor: Darvin Heck, Anderson, CA (US)

(21) Appl. No.: 14/045,722

(22) Filed: Oct. 3, 2013

Related U.S. Application Data
(60) Provisional application No. 61/713,624, filed on Oct. 15, 2012.

(51) Int. Cl. G02B 7/02; G03B 17/12

(52) U.S. Cl. CPC G02B 7/02; G03B 17/12
USPC 396/420; 359/812

(57) ABSTRACT

A device to both support and focus a long camera lens is described. A user can hold the camera body with one hand and the support device with the other. In this way, it is easy to hold the camera steady while composing and taking a photograph, as the weight of the lens is supported in more than one place using both hands. The device can be attached to the focusing and/or zoom ring of a zoom or other lens, so that the hand holding the device can move the device to focus the camera. Such a device will be welcomed by both novice and professional photographers because it will help to prevent cramping and fatigue that can occur in the hands with extended camera use. In addition use of the device can also increase camera lens stability, especially for users with unsteady hands.

### CROSS-REFERENCE TO RELATED APPLICATIONS

This application claims priority to U.S. Provisional Patent Application 61/713,624, filed Oct. 15, 2012, which is incorporated by reference herein.

### BACKGROUND OF THE INVENTION

### Field of the Invention

This invention relates generally to a device that helps a user to hold a cylindrical object, and, more specifically, to a hand-held device for supporting and focusing a camera or video lens or a spotting scope.

Cameras, such as single lens reflex (SLR) cameras can be used with a wide variety of interchangeable lenses for various kinds of photography. In particular, zoom lenses designed for focusing on objects far away, are actually complex lens systems with many individual lens elements arranged precisely within a cylindrical- or cone-shaped housing. Such zoom lenses can weigh as much as ten pounds or more. A camera body to which such a lens can be attached weighs generally less than two pounds.

A user holds the camera body and looks through a view finder or at a screen on the body to compose a desired shot. It can be difficult to balance the camera assembly and to hold it steady as the shot is composed. Even if the user has enough hand strength to hold and focus such a heavy camera and lens, cramping and fatigue can set in during long use.

A tripod can be attached to the camera body to support the weight of camera and lens and to ensure that the camera is held steady. Thus, the user's hands are free to compose and focus without also having to also support the weight of the camera.

Unfortunately, it is not always convenient to use a tripod. The tripod is yet one extra piece of bulky equipment to bring along with other camera equipment. By its very nature, a tripod keeps the camera fixed to a particular spot, making it difficult to change the camera position quickly to shoot photos of moving objects.

What is needed is a device for a camera that is small, lightweight, portable, and can help the user to support and steady a camera easily.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic illustration of an SLR camera with a long lens.

FIG. 2A is a schematic illustration that shows a lens support (and focusing aid), according to an embodiment of the invention.

FIG. 2B is a schematic illustration that shows how the lens support of FIG. 2A fits around a cylindrical lens, according to an embodiment of the invention.

FIG. 3A is a schematic illustration of a lens support whose cradle defines a circular arc that is more than 180°.

FIG. 3B is a schematic illustration of a lens support whose cradle defines a circular arc that is less than 180°.

FIG. 3C is a schematic illustration of a lens support wherein the interior and exterior sides of its cradle are not parallel.

FIG. 4A is a schematic illustration of a lens support that also includes a coupling attached to the cradle so that a lens can be completely enclosed.

FIG. 4B is a schematic illustration that shows examples of various attaching mechanisms that can be used to attach the coupling to the cradle.

FIG. 5A is a schematic illustration of a lens support that also includes a flexible coupling strip attached to the cradle so that a lens can be completely enclosed, according to an embodiment of the invention

FIG. 5B is a schematic illustration that shows how a hook and loop material can be used as a coupling strip.

FIG. 6 is a schematic illustration that shows how a flexible strip can be used as a coupling strip, according to another embodiment of the invention.

FIG. 7 is a schematic illustration that shows how a lens support can be used with a camera that has a cylindrical lens, according to an embodiment of the invention.

FIG. 8 is a schematic illustration that shows how a lens support can be used with a camera that has a conical lens, according to an embodiment of the invention.

### SUMMARY

A supporting device for a camera or video lens or a spotting scope is disclosed herein. The device has a first element that has an inner surface whose shape defines a circular arc and is configured to partly encircle a cylindrical element. The device has a second element adapted to attach to the first element and configured to continue the circular arc defined by the first element to further encircle the cylindrical element. There is also a handle attached to the first element.

The first element defines a circular arc that ranges between about 30° and 300° or between about 160° and 270°. The term “arc” is used herein to mean an unbroken part of the circumference of a circle or other curved line. In one arrangement, the first element defines a semicircular arc. Both the first element and the second element can be made of any one or more of a variety of materials. Examples include plastic, metal, such as aluminum, wood, hard rubber, composite materials, ceramics, and carbon fiber. In one arrangement, the first element also has additional material, such as felt, plastic, rubber, foam, smooth metal, the loop (soft, fuzzy) fabric strip of a hook and loop fastener pair, or soft fabric along its inner surface. In another arrangement, the second element also has additional material, such as felt, plastic, rubber, foam, smooth metal, the loop (soft, fuzzy) fabric strip of a hook and loop fastener pair, or soft fabric along its inner surface.

One end of the second element can be permanently or removably attached to one end of the first element. In some arrangements, the permanent attachment is a hinge. The opposite end of the second element can be removably attached to the opposite end of the first element.

In one arrangement, the second element is a flexible strip made of a material such as hook and/or loop material, rubber, plastic, or fabric.

The first end of the second element may be permanently attached to the first end of the first element with a hinge mechanism. The second end of the second element may be configured to be removably attached to the second end of the first element.

The first end of the second element may be configured to be removably attached to the first end of the first element. The second end of the second element may be configured to be removably attached to the second end of the first element.

In one arrangement, the second element is a flexible strip. The flexible strip may be made of one or more of hook and/or loop material, rubber, plastic, and fabric.

In one arrangement, there is a first fitting configured for threading the flexible strip. The first fitting may be located on an exterior surface of the first element on or near the second end of the first element. The flexible strip may be configured to pass through the first fitting and wrap back upon itself to be secured.

In another arrangement, there is a second fitting configured for threading the flexible strip. The second fitting may be located on an exterior surface of the first element on or near the first end of the first element. The flexible strip may be configured to pass through the first fitting, wrap back upon itself, pass through the second fitting, and wrap back upon itself to be secured.

In another embodiment of the invention, a device for a camera lens has an element whose shape defines a circular arc. The element is configured to partly encircle a camera lens around a focusing or zoom ring. A flexible strip is adapted to attach to the element and is configured to continue the circular arc to encircle the focusing or zoom ring entirely. There is also a handle attached to the element.

The first end of the flexible strip may be configured to be removably attached to the first end of the element, and the second end of the flexible strip may be configured to be removably attached to the second end of the element. There may also be a first fitting configured for threading the flexible strip on the exterior surface of the element on or near the second end of the element. There may also be a second fitting configured for threading the flexible strip on the exterior surface of the element on or near the first end of the element. The flexible strip may be configured to pass through the first fitting, wrap back upon itself, pass through the second fitting, and wrap back upon itself to be secured.

In another embodiment of the invention, a method of operating a camera includes providing a camera that has a camera body and a protruding cylindrical lens, the lens having a focusing and/or zoom ring; providing a supporting device for the protruding lens; securing the supporting device around the focusing and/or zoom ring; stabilizing the camera body on a tripod or with one hand; holding the handle of the supporting device with another hand; and moving the handle to turn the focusing and/or zoom ring to focus and/or zoom the cylindrical lens.

The supporting device has a first element whose inner surface has a shape that defines a circular arc. The first element is configured to partly encircle the focusing and/or zoom ring. There is also a second element that is adapted to attach to the first element and to further encircle the focusing and/or zoom ring. There is also a handle attached to the first element.

### DETAILED DESCRIPTION

The preferred embodiments are illustrated in the context of supporting long lenses attached to single lens reflex cameras. The skilled artisan will readily appreciate, however, that the materials and methods disclosed herein will have application in a number of other contexts where simple, hand-held support of elongated articles is desirable, particularly where portability is important.

The aforementioned needs are satisfied by the embodiments of the present invention as disclosed herein.

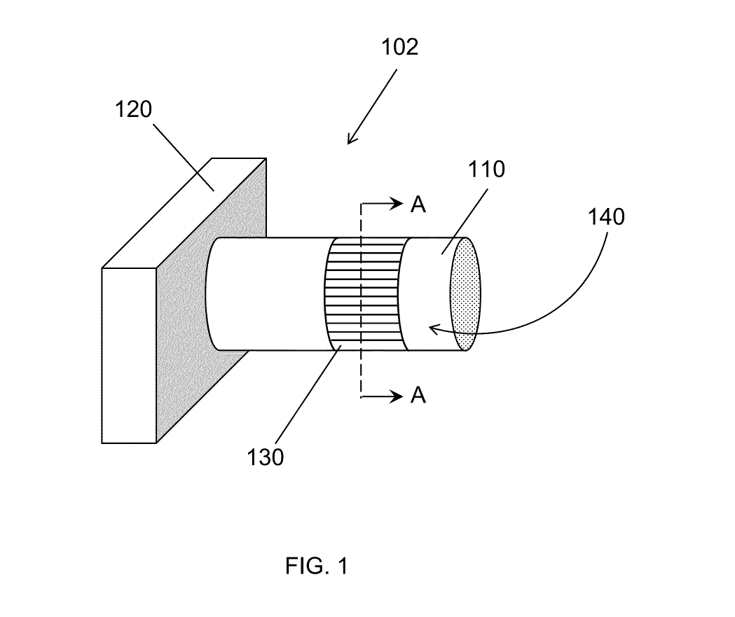

FIG. 1 is a schematic perspective drawing of a camera assembly 102 that has a long lens 110 attached to a camera body 120. A user holds the camera body 120 with one hand and, with the other hand, can turn a focusing or zoom ring 130 to focus the lens 110 on a desired object. As described above, the lens 110 can be much heavier than the body, causing the center of gravity for the camera assembly 102 to be far away from the camera body 120. Thus, when the camera assembly 102 is held away from the camera body 120, it is difficult to hold the camera assembly 102 steady, especially when it takes some time to compose and focus a desired shot.

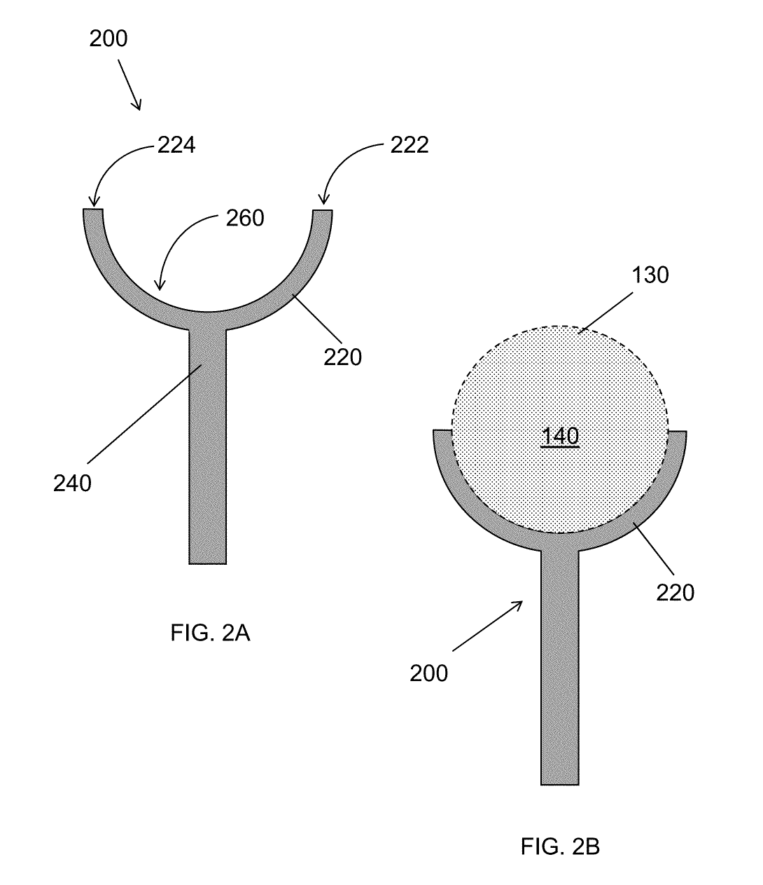

FIG. 2A is a schematic illustration that shows a lens support (and focusing aid) 200, according to an embodiment of the invention. The lens support 200 has a cradle portion 220 and a handle portion 240. The cradle 220 defines a circular arc and is designed to at least partially encircle a camera lens. The cradle 220 has a first end 222 (224) and a second end 224 (222) opposite the first end 222 (224). The cradle 220 has an interior surface 260 that is designed to fit a focusing or zoom ring 130 or anywhere else along a camera lens 110. The surface 260 can be made of any material that can make contact to the lens 110 or the focusing or zoom ring 130 without causing any damage to the lens 110 or the focusing or zoom ring 130. In some arrangements, the interior surface 260 is simply a smoothed or polished surface of the cradle 220, and no additional material is added. In other arrangements, the interior surface 260 is a separate material that lines the cradle 220 and can grip the lens without slipping. Examples of suitable materials for the interior surface 260 include, but are not limited to, felt, plastic, rubber, foam, smooth metal, the loop (soft, fuzzy) fabric strip of a hook and loop fastener pair, and soft fabric. In another arrangement, the cradle 220 can be attached to the lens 110 or focusing or zoom ring 130 using a bonding material such as glue or epoxy. In one arrangement, the cradle 220 is positioned on the focusing or zoom ring 130. In another arrangement, the cradle 220 is positioned anywhere along the length of the lens 110.

The cradle 220 can be made of any of a variety of materials. Materials that are light in weight can be especially useful, as they will add only a very small amount of additional weight to a camera assembly. Examples of suitable cradle material include, but are not limited to, plastic, metal, such as aluminum, wood, hard rubber, composite materials, ceramics, and carbon fiber. In one arrangement, the cradle 220 is rigid. In another arrangement, the cradle 220 is flexible, while still being able to support a lens.

The handle 240 is attached to the cradle 220. Such attachment can be effected by making the support 200 as one piece or by providing the cradle 220 and the handle 240 separately and then joining them together. In one arrangement, the cradle 220 and the handle 240 are joined together mechanically with a screw fitting, a bolt fitting, a clip fitting, a bayonet fitting, or any other such fitting as would be known to a person of ordinary skill in the art. Such fittings are especially useful if a user desires to disassemble the lens support 200 from time to time. In another arrangement, the cradle 220 and the handle 240 are bonded together, for example, with adhesive, or by welding or fusing. Examples of suitable handle 240 materials include, but are not limited to, plastic, metal, such as aluminum, wood, hard rubber, composite materials, ceramics, and carbon fiber. In some arrangements, the handle 240 is made of the same material as the cradle 220. In other arrangements, the handle 240 is not made of the same material as the cradle 220. Although the handle 240 is shown attached to the center of the cradle 220 in FIG. 2A, it should be understood that the handle 240 can be attached anywhere along the exterior surface of the cradle 260.

FIG. 2B is a schematic illustration that shows how the lens support 200 fits with a cylindrical lens 140, according to an embodiment of the invention. It should be understood that the lens support can fit anywhere along the cylindrical lens 110, such as at the focusing or zoom ring 130 (shown in FIG. 1). In FIG. 2B the lens 140 is viewed end-on as indicated in FIG. 1. The cradle 220 encircles a portion of the circumference of the lens 140. FIG. 2B shows that the cradle 220 fits against the lens 140 with no gaps. It should be understood that other arrangements are possible. For example, if the interior surface 260 is bumpy instead of smooth, there can be gaps between the cradle 220 and the lens 140. Or, if the cradle 220 is attached to the lens 140 at the focusing or zoom ring 130, there can be gaps between the two caused by ridges or roughness on the focusing or zoom ring 130. In some arrangements, a lens may be slightly smaller than the cradle 220. It is still possible to support such a lens with the lens support 200, even though the cradle 220 does not fit snugly along the sides of the lens.

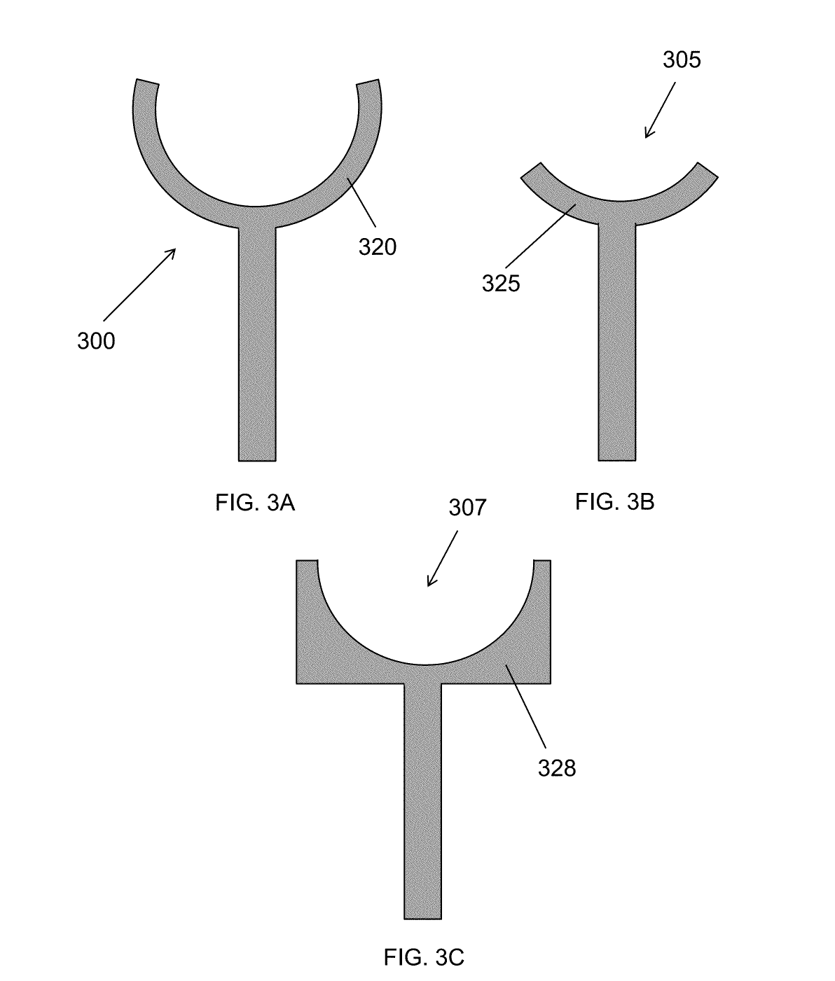

Although the shape of the cradle 220 shown in FIGS. 2A and 2B is a semicircular arc, other circular arc lengths are possible, as shown in the schematic illustrations in FIGS. 3A and 3B. In one embodiment of the invention, the cradle 220 defines a circular arc that ranges between about 30° and 300°. In another embodiment of the invention, the cradle 220 defines a circular arc that ranges between about 160° and 270°. In another embodiment of the invention, the cradle 220 defines a semicircular arc, allowing the lens to be supported along half its circumference, while providing an opening through which an appropriate-sized lens can be inserted and removed with little or no restriction from the cradle 220, i.e., the width of the opening is about the same size as the diameter of the lens or lens ring.

In an exemplary embodiment, FIG. 3A is a schematic illustration that shows a lens support 300 that has a cradle 320 whose circular arc extends farther than just half way around the circle (as for the semicircle). The larger cradle 320 may offer additional support to the lens. But it is important to avoid extending the circular arc so far that it is difficult or impossible to fit a lens into the cradle 320. The larger cradle 320 may be especially useful when the cradle material offers some flexibility.

In an exemplary embodiment, FIG. 3B is a schematic illustration that shows a lens support 305 that has a cradle 325 whose circular arc extends less than half way around the circle (as for the semicircle). Although the smaller cradle 320 may offer less support to the lens, it is smaller and more portable. In addition, the smaller cradle 320 may be able to fit a wider variety of lens sizes.

In an exemplary embodiment, FIG. 3C is a schematic illustration that shows a lens support 307 that has a cradle 328 whose interior and exterior sides are not parallel. This serves to illustrate that although many of the figures have shown cradles whose sides are parallel, there are other possibilities. Cradle 328 has an interior surface with a circular arc so that it can fit against a lens, but its exterior surface has a square surface. Other shapes for the exterior surface are also possible.

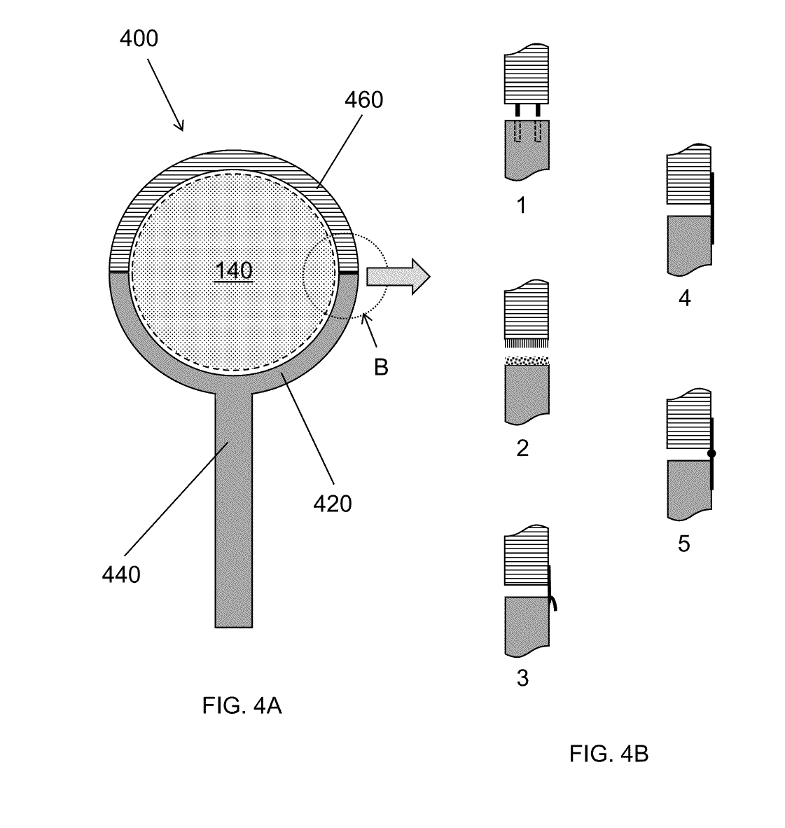

In one embodiment of the invention, the lens support has an additional feature, as shown in the schematic illustration in FIG. 4A. The lens support 400 has a coupling 460 that attaches to a cradle 420, enclosing a lens 140. The coupling 460 can be made of the same or different material than the cradle 420 and the handle 440. The coupling 460 has an interior surface similar to the interior surface of the cradle 120 as described above. The coupling surface can be made of any material that can make contact to a lens without causing any damage to the lens. In some arrangements, the coupling surface is simply a smoothed or polished surface of the coupling 460, and no additional material is added. In other arrangements, the coupling surface is a separate material that lines the coupling 460 and can grip the lens without slipping. Examples of suitable materials for the coupling surface include, but are not limited to, felt, plastic, rubber, foam, smooth metal, the loop (soft, fuzzy) fabric strip of a hook and loop fastener pair, and soft fabric.

The coupling 460 attaches to the cradle 420 to ensure that the lens 140 is gripped securely and to allow the lens support 400 to also be used as a focusing aid when the support 400 is attached to the focusing or zoom ring 130 of the lens 140. The coupling 460 can attach to the cradle 420 in any of a variety of ways. There is no limitation on the ways in which the coupling 460 can attach to the cradle 420. The junction area designated as B in FIG. 4A is enlarged and shown with various exemplary attaching mechanisms in FIG. 4B. Examples 1-5 can be described as follows:
1) Pins are attached to the coupling 460 (cradle 420) and they make a tight fit when pushed into holes in the cradle 420 (coupling 460);
2) A hook and loop type fastener is used with the hooks on the coupling 460 and the loops on the cradle 420 or vice versa;
3) A hook is attached to the cradle 420 (coupling 460), and a loop that can snag the hook is attached to the coupling 460 (cradle 420);
4) A strip of pliable material is attached across both the coupling 460 and the cradle 420 and can act as a hinge; and
5) A standard hinge is attached across both the coupling 460 and the cradle 420.
   Although the attaching mechanisms have been described with their individual elements assigned to the coupling 460 or the cradle 420, it should be understood that the placement of the various elements is arbitrary and they all can be reversed.

The attaching mechanisms shown in FIG. 4B can be divided into two different groups. The first group includes examples 1, 2, and 3, and can be used on one or both junctions of the cradle 420 with the coupling 460. When these attaching mechanisms (1, 2, 3) are used at both junctions, the coupling 460 can be removed from the cradle 420 completely. The lens support 400 can then be used with or without the coupling 460. The second group includes examples 4 and 5, which can be used only at one junction. These attaching mechanisms (4, 5) make a permanent attachment between the coupling 460 and the cradle 420. The coupling 460 can pivot on the hinge to move away from the lens 140 and allow the lens support 400 to be removed from the lens 140. When hinges from the second group are used on one junction, it is useful to use one of the attaching mechanisms from the first group at the opposite junction.

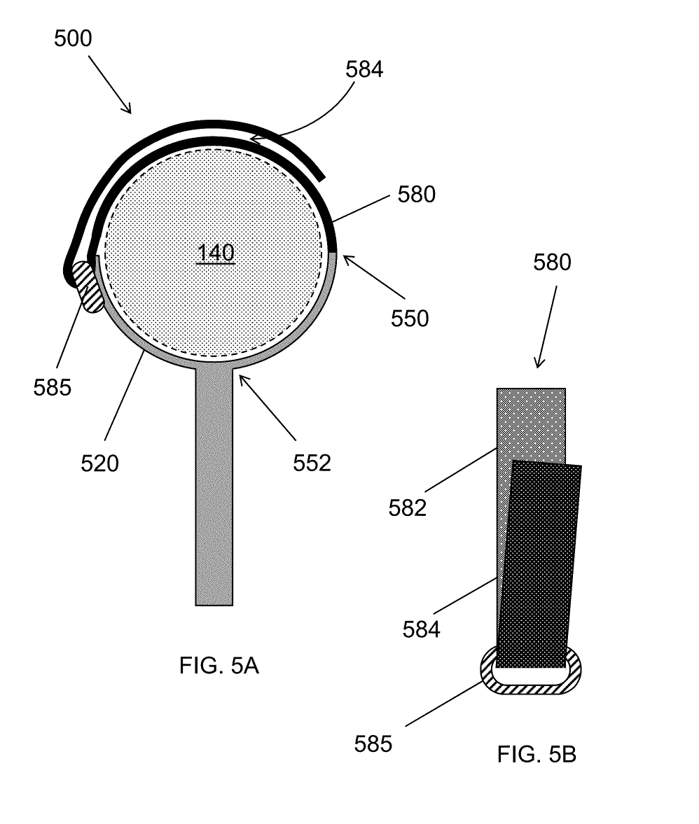

In another embodiment of the invention, a lens is secured to a cradle using a flexible strip coupling, as shown in the schematic illustration in FIG. 5A. A lens support 500 has the same basic components as shown above in FIG. 2A-2B. A coupling strip 580 is attached at one end to one side of a cradle 520. It should be understood that the coupling strip 580 can attach anywhere along the cradle between points 550 and 552. In some arrangements, the coupling strip 580 is joined to the edge of the cradle 520, such as at 550. In other arrangements, the coupling strip 580 overlaps the cradle 520 along the cradle exterior (on the right of the cradle 520 as viewed in FIG. 5A) and can extend to any point between 550 and 552. The actual attachment may be all along the overlap between the coupling strip 580 and the cradle 520 or it may be in one or more specific regions of the overlap between the coupling strip 580 and the cradle 520. The strip 580 can be made of any flexible material. Examples include, but are not limited to, rubber, webbing, plastic, hook and/or loop material, and cloth. In one arrangement, the strip 580 has hook material on one side and loop material on the opposite side. The strip 580 can be attached to the cradle 520 in any of a variety of ways. In one arrangement, the strip 580 is attached mechanically with a screw fitting, a bolt fitting, a clip fitting, or any other such fitting as would be known to a person of ordinary skill in the art. In another arrangement, the strip 580 is attached to the cradle 520 by bonding, such as with adhesive or by fusing. The strip 580 may be attached either permanently or removably.

Once a lens 140 has been placed in the cradle 520, the strip 580 can be pulled over the lens and looped through a fitting 585, such as an eyelet, at the opposite side of the cradle 520. The fitting 585 may be an elongated loop, shown here end on. Another view of the fitting 585 can be seen in FIG. 5B. Many configurations of the fitting 585 are possible as long as they allow the strip 580 to be held and to pivot back upon itself. The location of the fitting 585 can be anywhere along the cradle exterior (on the left of the cradle 520 as viewed in FIG. 5A). After the strip 580 is passed through the fitting 585, it is pulled over the lens again in the opposite direction. In some arrangements, for example when the coupling strip 580 has hook material on one side and loop material on the opposite side, the strip 580 is then secured upon itself along 584 to hold the lens 140 (or focusing ring) in place. FIG. 5A shows a gap at 584 to illustrate the relative positions of the two portions of the coupling strip 580. In general, there is no gap at 584 because the coupling strip is pulled tightly whether it is secured upon itself or not. Various kinds of attachment mechanisms (not shown) can be used to secure the strip 580 upon itself. Using the strip 580 as the coupling for the lens 140 has the advantage that it can be pulled as tightly as one likes as it is looped through the fitting 585. This is especially advantageous when a lens is smaller than the size for which the cradle 520 was designed. Once the strip 580 is pulled tightly over the lens, it can still be held in place. In one arrangement, the cradle is made of a flexible material, such as a flexible plastic, so the as the coupling loop 580 is pulled tightly over the lens 140, the sides of the cradle 520 bend inward, ensuring that the lens support 500 grips the lens 140 (or focusing or zoom ring) tightly. In this paragraph and the preceding one, portions of FIG. 5A have been referred to as “left” and “right.” It should be understood that these designations have been used merely to distinguish one side of the cradle 520 from the other, and do not carry any absolute meaning.

FIG. 5B is a schematic illustration that shows how a hook and loop material can be used as a coupling strip 580, according to an embodiment of the invention. Only a portion of the strip 580 is shown. The strip 580 has hook material on one side and loop material on the opposite side. The strip 580 is arranged so that the first portion 582 whose underside (not shown) is directly against the lens 140 has its hook (loop) side facing out of the page. The strip 580 has been threaded through the fitting 585 and, the second portion 584 has been pulled tightly. The second portion 584 has its underside facing out of the page and its loop (hook) side facing the hook (loop) side of the first portion 582. The second portion 584 can be pressed against the first portion 582 to secure the coupling strip 580.

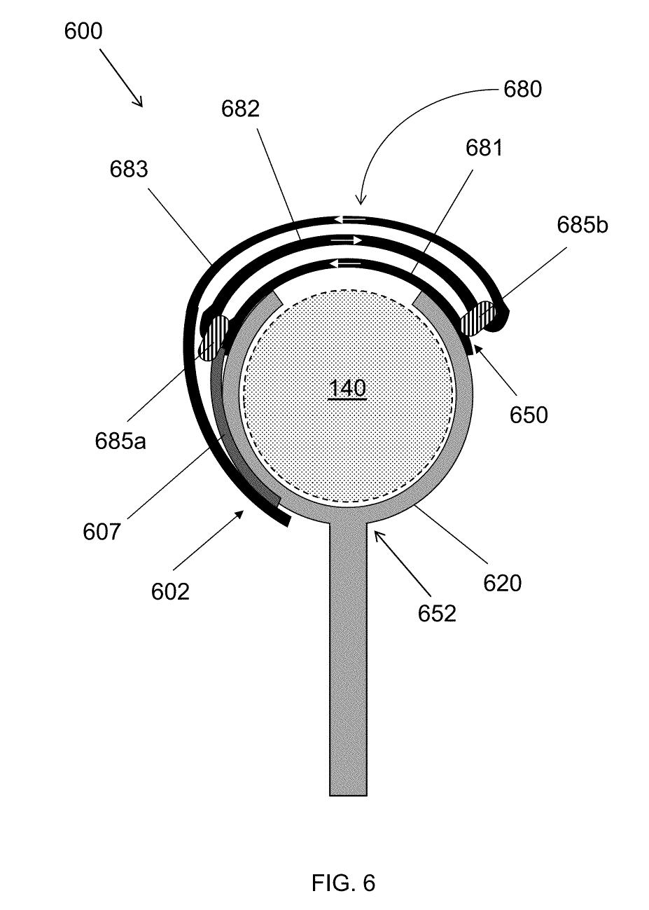

FIG. 6 is a schematic illustration that shows how a flexible strip can be used as a coupling strip, according to another embodiment of the invention. A lens support 600 has the same basic components as shown above in FIG. 2A-2B. A coupling strip 680 is attached at one end to one side of a cradle 620. It should be understood that the coupling strip 680 can attach anywhere along the cradle between points 650 and 652. In some arrangements, the coupling strip 680 is joined to the edge of the cradle 620, such as at 650. In other arrangements, the coupling strip 680 overlaps the cradle 620 along the cradle exterior (on the right of the cradle 620 as viewed in FIG. 6) and can extend to any point between 650 and 652. The actual attachment may be all along the overlap between the coupling strip 680 and the cradle 620 or it may be in one or more specific regions of the overlap between the coupling strip 680 and the cradle 620. The strip 680 can be made of any flexible material. Examples include, but are not limited to, rubber, webbing, plastic, hook and/or loop material, and cloth. In one arrangement, the strip 680 has hook material on one side and loop material on the opposite side. The strip 680 can be attached to the cradle 620 in any of a variety of ways. In one arrangement, the strip 680 is attached mechanically with a screw fitting, a bolt fitting, a clip fitting, or any other such fitting as would be known to a person of ordinary skill in the art. In another arrangement, the strip 680 is attached to the cradle 620 by bonding, such as with adhesive or by fusing. The strip 680 may be attached either permanently or removably.

Once a lens 140 has been placed in the cradle 620, a first segment 681 of the strip 680 can be pulled over the lens in the direction shown by the white arrow and looped through a first fitting 685a at the opposite side of the cradle 620. The fitting 685a is shown as an elongated loop, shown here end on. This is similar to the fitting 585 as shown in FIG. 5B. After the first segment 681 is passed through the fitting 685a, a second segment 682 it is pulled back over the lens in the direction indicated by the white arrow. The segment 682 is then looped through a second fitting 685b at the starting side of the cradle 620. After the second segment 682 is passed through the fitting 685b, a third segment 683 is pulled back over the lens in the direction indicated by the white arrow. The segment 683 is then attached to a region 607 of the cradle 620. Many configurations of the fittings 685a and 685b are possible as long as they allow the strip 680 to be held and to pivot back upon itself. One example of a useful fitting is an eyelet. The location of the fittings 685a and 685b can be anywhere along the cradle exteriors, i.e., along the left of the cradle 620 and along the right of the cradle 620 as viewed in FIG. 6.

Various kinds of attachment mechanisms (not shown) can be used to secure the strip 680 onto region 607. In one example, the region is a hook (or loop) material that can grab a loop (or hook) material on the segment 683. In one arrangement, one or more segments 681, 682, 683 has one or more surface that can attach to adjacent segments. One advantage in looping the strip 680 back and forth a few times is that at each turning point, i.e., at fittings 685a and 685b, the strip 680 can be pulled tightly, thus ensuring a snug grip on the lens 140 (or focusing ring).

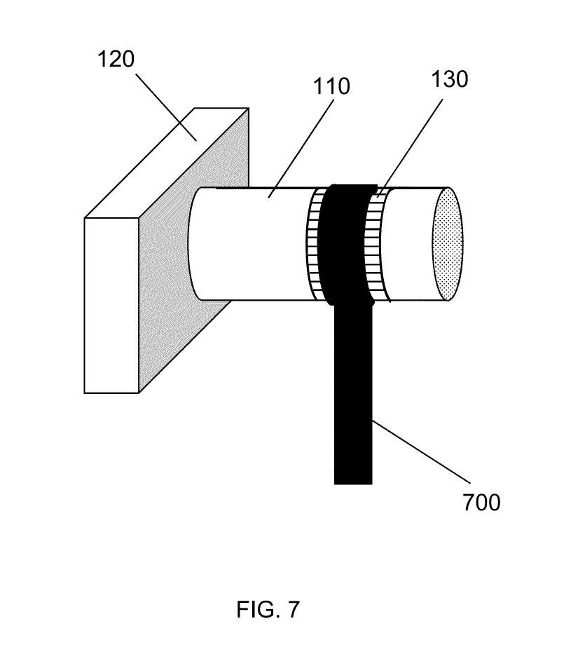

A camera with a lens support as described above is show in the schematic perspective illustration in FIG. 7. The lens support 700 is attached to the focusing or zoom ring 130 of the lens 110. With this assembly, a user can hold the camera body 120 with one hand and the handle of the lens support 700 with the other. The weight of the lens is more evenly distributed to both hands. Thus the camera lens 110 can be supported comfortably by the user with little or no hand strain. Furthermore, the lens support 700 can be used to focus or zoom the lens on an object of interest. The user can move the handle from side to side to turn the focusing or zoom ring using the whole arm rather than just the wrist. This can be a particular advantage for users suffering from hand pain, wrist pain, or reduced mobility due to ailments such as carpal tunnel syndrome, arthritis, or injury.

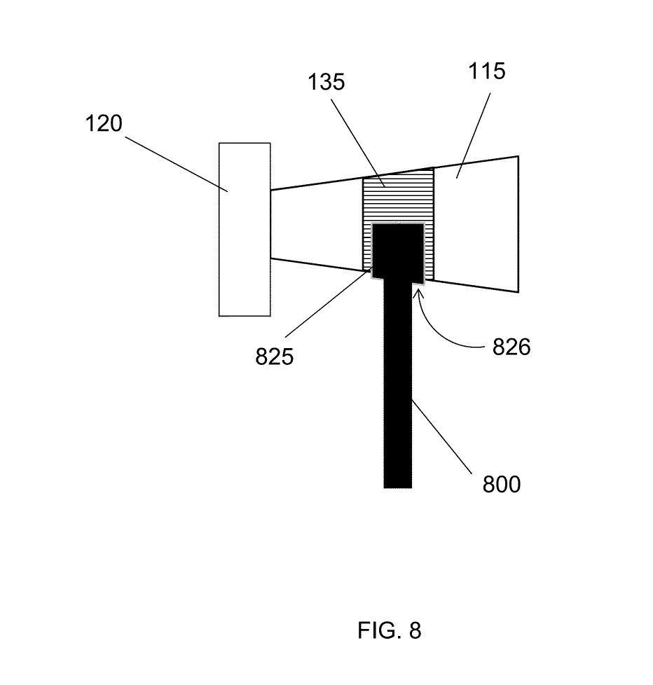

A camera with a lens 115 that is conical instead of cylindrical is show in the schematic side-view illustration in FIG. 8. A cradle 825 of a lens support 800 is attached to the focusing ring 135 of the conical lens 115. In one embodiment of the invention, as shown in FIG. 8, the cradle bottom 826 has been adapted to echo the slant of the conical lens 115 in order to ensure a good fit against the focusing ring 135. Many variations are possible for the external shape of a cradle designed to fit a conical lens as have been discussed above with reference to a cylindrical lens. But rather than having a flat interior surface, such a cradle has a slanted interior surface designed to hug a cylindrical lens. Any of the couplings described above with reference to a cylindrical lens can also be used with a cradle designed for a cylindrical lens. For couplings such as those shown in FIGS. 4A and 4B, it is useful if the interior surfaces are slanted so that the coupling can fit well against a cylindrical lens. Flexible strip couplings as shown in FIGS. 5A, 5B and 6 can also be used with a cradle designed for a conical lens. It is especially important that the cradle 825 fits against the focusing ring 135 without slipping. Otherwise, the cradle 825 and entire lens support 800 may slide off the focusing ring during use.

With this assembly, a user can hold the camera body 120 with one hand or mount the camera body 120 on a tripod or other camera holding device. The used can use any free hand to hold the handle of the lens support 800. The weight of the lens is more evenly distributed to both hands (in the case where no other camera holding device is used). Thus the camera lens 115 can be supported comfortably by the user with little or no hand strain. Furthermore, the lens support 800 can be used to focus or zoom the lens on an object of interest. The user can move the handle from side to side to turn the focusing or zoom ring using the whole arm rather than just the wrist. This can be a particular advantage for users suffering from hand pain, wrist pain, or reduced mobility due to ailments such as carpal tunnel syndrome, arthritis, or injury.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A supporting device for a camera lens comprising;
a first element having an inner surface whose shape defines a circular arc, the first element configured to partly encircle a cylindrical element, the first element having a first end and a second end opposite the first end;
a second element adapted to attach to the first element, the second element configured to continue the circular arc to encircle further the cylindrical element; and
a handle attached to the first element.

2. The device according to claim 1 wherein the first element defines a circular arc that ranges between about 30° and 300°.

3. The device according to claim 1 wherein the first element defines a circular arc that ranges between about 160° and 270°.

4. The device according to claim 1 wherein the first element defines a semicircular arc.

5. The device according to claim 1 wherein the first element is made of one or more materials selected from the group consisting of plastic, metal, wood, hard rubber, composite materials, ceramics, and carbon fiber.

6. The device according to claim 1 wherein the first element further comprises an additional material along the inner surface.

7. The device according to claim 6 wherein the additional material is selected from the group consisting of felt, plastic, rubber, foam, smooth metal, the loop fabric strip of a hook and loop fastener pair, and soft fabric.

8. The device according to claim 1 wherein the second element is made of one or more materials selected from the group consisting of plastic, metal, wood, hard rubber, composite materials, ceramics, and carbon fiber.

9. The device according to claim 1 wherein the second element has a first end and a second end opposite the first end, wherein;
the first end of the second element is permanently attached to the first end of the first element with a hinge mechanism; and
the second end of the second element is configured to be removably attached to the second end of the first element.

10. The device according to claim 1 wherein the second element has a first end and a second end opposite the first end, wherein;
the first end of the second element is configured to be removably attached to the first end of the first element; and
the second end of the second element is configured to be removably attached to the second end of the first element.

11. The device according to claim 1 wherein the second element comprises a flexible strip.

12. The device according to claim 11 wherein the flexible strip comprises a material selected from the group consisting of hook and/or loop material, rubber, plastic, and fabric.

13. The device according to claim 11 further comprising a first fitting configured for threading the flexible strip, the first fitting located on an exterior surface of the first element on or near the second end of the first element.

14. The device according to claim 13 wherein the flexible strip is configured to pass through the first fitting and wrap back upon itself to be secured.

15. The device according to claim 13 further comprising a second fitting configured for threading the flexible strip, the second fitting located on an exterior surface of the first element on or near the first end of the first element.

16. The device according to claim 14 wherein the flexible strip is configured to pass through the first fitting, wrap back upon itself, pass through the second fitting, and wrap back upon itself to be secured.

17. A device for a camera lens comprising;
an element having an inner surface whose shape defines a circular arc, the element configured to partly encircle a camera lens around a focusing or zoom ring, the element having a first end and a second end opposite the first end;
a flexible strip adapted to attach to the element, the flexible strip configured to continue the circular arc to encircle the focusing or zoom ring entirely; and
a handle attached to the element.

18. The device according to claim 1 wherein the flexible strip has a first end and a second end opposite the first end, wherein;
the first end of the flexible strip is configured to be removably attached to the first end of the element; and
the second end of the flexible strip is configured to be removably attached to the second end of the element.

19. The device according to claim 11 further comprising:
a first fitting configured for threading the flexible strip, the first fitting located on an exterior surface of the element on or near the second end of the element;
a second fitting configured for threading the flexible strip, the second fitting located on an exterior surface of the element on or near the first end of the element;
wherein the flexible strip is configured to pass through the first fitting, wrap back upon itself, pass through the second fitting, and wrap back upon itself to be secured.

20. A method of operating a camera comprising the steps of:
a) providing a camera that has a camera body and a protruding cylindrical lens, the lens having a focusing and/or zoom ring;
b) providing a supporting device for the protruding lens, the supporting device comprising;
a first element having an inner surface whose shape defines a circular arc, the first element configured to partly encircle the focusing and/or zoom ring, the first element having a first end and a second end opposite the first end;
a second element adapted to attach to the first element, the second element configured to further encircle the cylindrical element; and
a handle attached to the first element;
c) securing the supporting device around the focusing and/or zoom ring;
d) stabilizing the camera body on a tripod or with one hand;
e) holding the handle of the supporting device with another hand;
f) and moving the handle to turn the focusing and/or zoom ring to focus and/or zoom the cylindrical lens.
